(19) United States
(12) Patent Application Publication
(10) Pub. No.: US 2018/0193829 A1
(43) Pub. Date: Jul. 12, 2018

(54) DROPLET RECUPERATION METHOD AND ASSOCIATED DROPLET RECUPERATION SYSTEM

(71) Applicants: ECOLE SUPERIEURE DE PHYSIQUE ET DE CHIMIE INDUSTRIELLES DE LA VILLE DE PARIS, PARIS (FR); Centre national de la recherche scientifique, PARIS (FR)

(72) Inventors: Laurent BOITARD, PARIS (FR); Nicolas BREMOND, PARIS (FR); Jaïro GARNICA RODRIGUEZ, PARIS (FR); Jérôme BIBETTE, PARIS (FR)

(21) Appl. No.: 15/741,885

(22) PCT Filed: Jul. 7, 2016
(86) PCT No.: PCT/EP2016/066180

§ 371 Date: Jan. 4, 2018

(30) Foreign Application Priority Data
Jul. 7, 2015 (FR) 15 56424

(51) Int. Cl. B01L 3/02; B01L 3/00

(52) U.S. Cl. CPC B01L 3/0241; B01L 3/502761; B01L 2400/0487; B01L 2200/0673; B01L 2300/0819; B01L 3/502784

(57) ABSTRACT

The invention relates to a method for recuperating droplets (4), includes:
supplying a chip (20) comprising a fluid circulation duct (46),
injecting an emulsion (6) of droplets,
injecting a carrier fluid (26) to form a working fluid (28) containing droplets of the emulsion which are spaced apart along the duct,
conveying the working fluid through the duct,
injecting a separating fluid (33) in order to separate the working fluid into a plurality of successive pockets (35), wherein each pocket is isolated from the next pocket by a separator (80),
conveying the pockets and separators towards an outlet (66) of the chip,
recuperating in a compartment (82) of a recuperation support (34) at least one pocket containing a droplet recuperated after conveying.

The present invention relates to a method for recuperating droplets comprising the following steps:
supply of a chip comprising a fluid circulation duct defining successively in the sense of the flow of the fluids, an inlet zone, a spacing zone, an injection zone and a separation zone,
injection of an emulsion of droplets of an internal fluid dispersed in an external fluid, in the inlet zone,
injection of at least one carrier fluid that is miscible with the external fluid in the spacing zone, to form a working fluid in the circulation duct comprising the carrier fluid and droplets of the emulsion spaced apart from one another along the duct,
conveyance of the working fluid in the circulation duct.

The process according to the invention makes it possible, for example, to form an emulsion droplet by droplet with a defined content or to reinject an emulsion, then to space the droplets of the emulsion apart before isolating them one by one on a solid support. The solid support may be, for example, a 96, 386 or 1536-well plate, or a petri dish, or a MALDI plate.

An emulsion is a heterogeneous mixture of two immiscible liquids, in the form of droplets of the first liquid in the second.

Droplet microfluidics is used in a large number of laboratories to miniaturize biological and biochemical reactions in bioreactors from a few picoliters to a few nanoliters. Sampling speeds, more than 1000 droplets per second and reduced sample volume, make this technology very attractive for the screening of molecules and cells. Over the last 10 years, a large number of modules have been developed to manipulate these micrometric droplets: mixing and addition of compounds, droplet fusing, detection of fluorescent markers, incubation and droplet selections of interest.

The publication “Fluorescence-activated droplet sorting (FADS): Efficient microfluidic cell sorting based on enzymatic activity”, by Baret et al. published online 23 Apr. 2009 in the journal Lab on a Chip illustrates this principle.

An emulsion of droplets is injected into a sorting device, wherein the droplets of the emulsion are spaced apart through an injection of fluorinated oil without surfactant. The droplets are then sent to a sort interface. A measurement is made, wherein all the droplets having a signal greater than a detection threshold are collected in the same tube. Such a system allows the separation of the emulsion into two droplet populations and the recuperation of each population.

However, this method does not allow the recuperation of the droplets individually.

But, it is important in some applications to be able to recuperate isolated droplets in a macroscopic support.

For example, in the field of high-throughput screening of cells, it may be desired to test numerous isolated cells simultaneously, then to select and recuperate the most interesting cells. The isolation of the cells in separate droplets facilitates the tests, then the re-culturing of the selected cells makes it possible to obtain clones generating monoclonal antibodies or industrial enzymes.

With the method previously described, about one thousand mixed droplets are recuperated together at the outlet of the system, and thus many subsequent steps are required to isolate the cells with the best arrangements in order to synthesize the compound of interest. Alternatively, the method described above may be used to recuperate only one droplet but this is difficult to implement because of the small volume of the droplet to be handled and, in addition, in this case, the rest of the droplets are lost or eliminated.

The publication “Interfacing picoliter droplet microfluidics with addressable microliter compartments using fluorescence activated cell sorting” by Bai et al., published online on 23 Dec. 2013 in the journal Sensors and Actuators B: Chemical, provides a method for isolating droplets one by one. This method consists in gelling the droplets containing the molecules or cells of interest before placing them in a fluorescence activated cell sorter cytometer (called FACS for Fluorescence Activated Cell Sorter) which then distributes them in a plate.

However, many droplets are lost. In addition, a major disadvantage of this method is the gelling step of the droplet which imposes temperature conditions that are not necessarily compatible with all biochemical or biological reactions. In fact, the authors place their samples in an ice bath, which would stop any reaction.

The patent application WO2012042060 describes a system for producing and recuperating droplets. The droplets are generated at a compatible frequency synchronized with the speed of movement of the droplet recuperation element.

However, this system does not allow the reinjection of an emulsion. In addition, the separation of the droplets requires a large amount of oil which makes them difficult to handle. Finally, this system does not allow the addition of a reagent (lysis liquid for example) once the droplet is formed.

An object of the invention is to provide a more reliable and accurate droplet recuperation method than existing methods, allowing individual monitoring of each droplet and effective recuperation of its contents.

To this end, the object of the invention is a process of the aforementioned type, characterized in that the process comprises the following steps:
injection of an immiscible separating fluid with the carrier fluid into the injection zone in order to separate the working fluid into a plurality of successive pockets comprising carrier fluid, wherein each pocket is isolated from the next pocket by a separator consisting of separating fluid,
conveyance of the pockets and separator in the separation zone to an outlet of the chip,
recuperation in a compartment of a recuperation support of at least one pocket comprising a droplet recuperated after conveyance.

The method according to the invention may comprise one or more of the following characteristics, taken separately or in any technically feasible combination:
the circulation duct is wider in the separation zone than in the spacing zone,
each pocket comprises carrier fluid and strictly less than two droplets,
the output of the chip opens into an evacuation tube having an outlet,
the support comprises several compartments separated from one another, and the method comprises, after each recuperation step, a step of relative displacement of the support with respect to the chip, wherein the outlet of the evacuation tube is placed opposite a different compartment after each displacement of the support,
the method comprises a step of detecting the passage of successive droplets or detection of the passage of the successive pockets,
the displacement of the support is controlled as a function of each detection of droplets or of each pocket detection, so that only one pocket comprising a droplet detected at the detection step is recuperated in each compartment of the support,
the detection of a droplet controls the injection of a volume of separating fluid and the formation of a pocket,
the method comprises a step of detecting pockets in a detection zone downstream of the separation zone,
the process comprises a step of adding a complementary solution in at least one pocket,
the pocket in which the complementary solution is added comprises a droplet of emulsion, while the method comprises a step of fusing the said droplet of emulsion with the complementary solution added.
the formation of the pockets is carried out at a frequency of between 1 pocket per second and 1000 pockets per second;
the diameter of each droplet is less than or equal to that of the circulation duct 46;
the diameter of each pocket is greater than or equal to that of the circulation duct 46;
the diameter of each separator is greater than or equal to that of the flow duct 46, wherein the separating fluid is preferably a gas.

The invention also relates to a droplet recuperation system comprising:
a chip comprising a fluid circulation duct defining successively in the fluid flow direction, an inlet zone, a spacing zone, an injection zone and a separation zone,
a device for injecting an emulsion of droplets of an internal fluid dispersed in an external fluid, in the inlet zone,
a device for injecting at least one carrier fluid that is miscible with the external fluid in the spacing zone in order to form a working fluid in the flow duct comprising the carrier fluid and emulsion droplets spaced apart at intervals from others along the duct,
a device for injecting a separating fluid which is immiscible with the carrier fluid in the injection zone, in order to separate the working fluid into a plurality of successive pockets comprising the carrier fluid, wherein each pocket is isolated from the next pocket by a separator consisting of separating fluid, and
a control unit able to circulate the working fluid in the circulation duct and to convey the pockets and separators in the separation zone to an outlet of the chip,
a recuperation support, wherein the support comprises at least one compartment for the recuperation of at least one pocket comprising a droplet in the compartment.

The droplet recuperation system according to the invention may comprise one or more of the following characteristics, taken in isolation or in any technically feasible combination:
the outlet of the chip opens into a discharge tube having an outlet, wherein the support comprises several compartments separated from each other, while the system comprises a device for relative displacement of the support with respect to the chip after each recuperation, wherein the displacement device is able to place the outlet of the discharge tube opposite a different compartment after each displacement of the support relative to the chip,
the system comprises a sensor capable of detecting the passage of successive droplets in the spacing zone, wherein the displacement device is controlled according to each detection of droplets, so that a single pocket comprising a droplet detected at the step of detection is recuperated in each compartment of the support,
the outlet of the chip opens into an evacuation tube, wherein the evacuation tube defines an internal lumen opening on an open mouth, wherein the evacuation tube comprises an external wall, while the system comprises a mouthpiece having a through passage; wherein the discharge tube is placed in the through passage and the system comprises a blowing unit capable of injecting a flow of air into the through passage so that a portion of the air runs along the outer wall of the tube evacuation to the mouth of the discharge tube.

The invention also relates to a pocket distribution device comprising:
a discharge tube defining an internal lumen opening on an open mouth, wherein the discharge tube comprises an external wall;
a circulation device in the internal lumen of the discharge tube of a plurality of successive pockets comprising a carrier fluid, wherein each pocket is isolated from the next pocket by a separator constituted by a separating fluid, wherein the separating fluid is immiscible with the carrier fluid;
a mouthpiece having a through passage, wherein the discharge tube is placed in the through passage of the mouthpiece;
a blowing unit capable of injecting a flow of air into the through passage so that a portion of the air runs along the outer wall of the discharge tube to the mouth of the discharge tube.

The invention also relates to a pocket distribution method comprising the following steps:
provision of a distribution device as previously described;
putting into circulation successive pockets in the internal lumen,
injection of air into the through passage of the mouthpiece, wherein the air flow and the flow of the pockets is adjusted so that each pocket is detached successively from the mouth of the discharge tube.

The invention will be better understood upon reading the description which follows, and which is given solely by way of example, and with reference to the appended drawings:

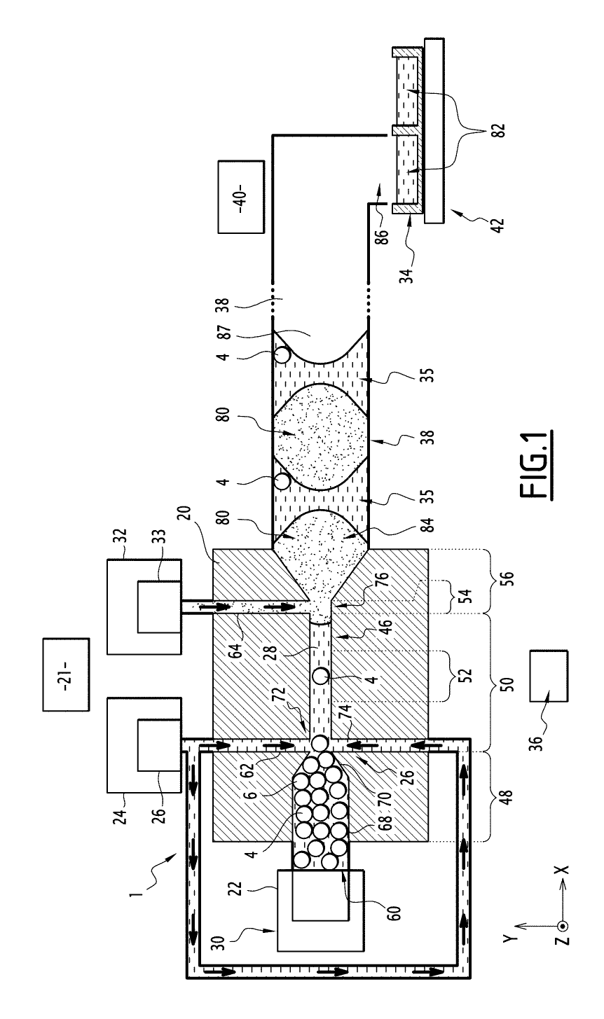

FIG. 1 shows a schematic representation of a first droplet recuperation system according to the invention,

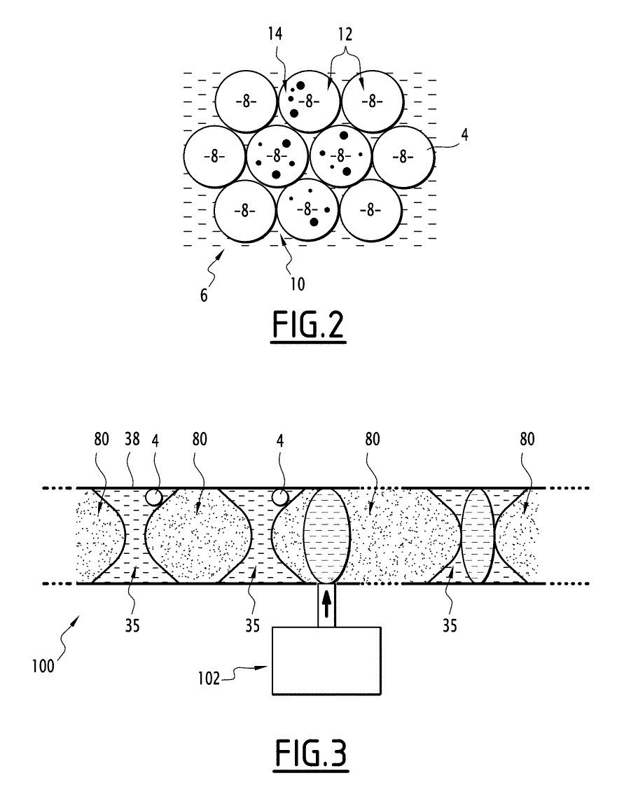

FIG. 2 shows a schematic representation of an emulsion prior to injection into the droplet recuperation system,

FIG. 3 shows a detailed representation of part of a second droplet recuperation system according to the invention,

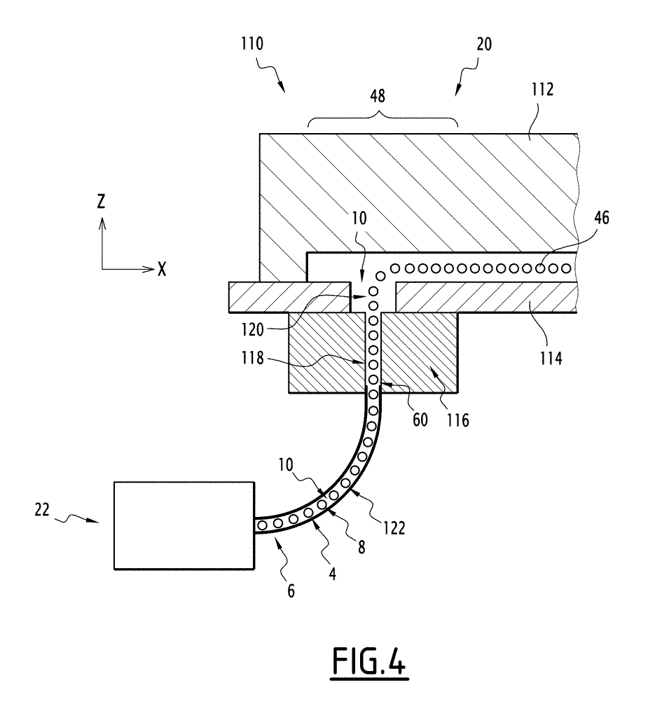

FIG. 4 shows a detailed representation of part of a third droplet recuperation system;

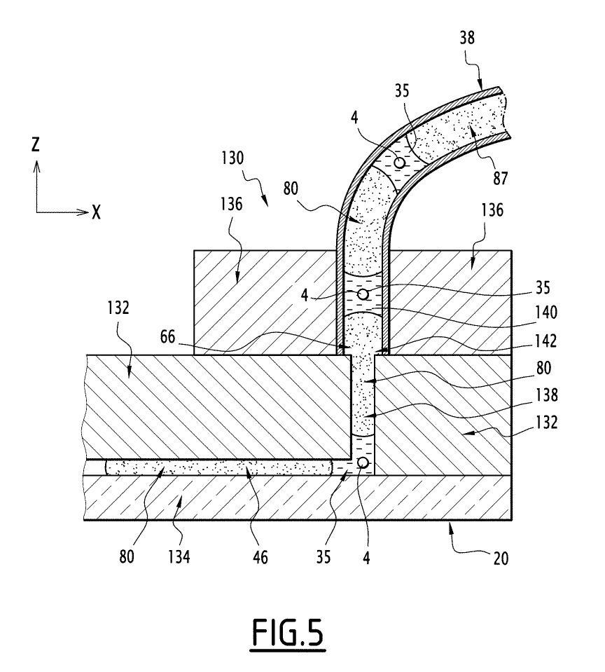

FIG. 5 shows a detailed representation of part of a fourth recuperation system;

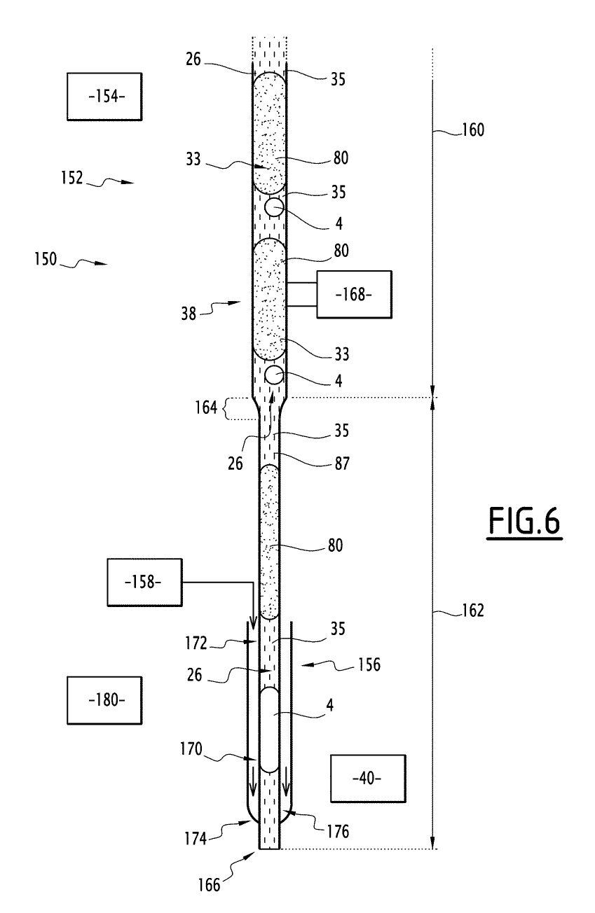

FIG. 6 shows a detailed representation of a pocket distribution device of a fifth recuperation system;

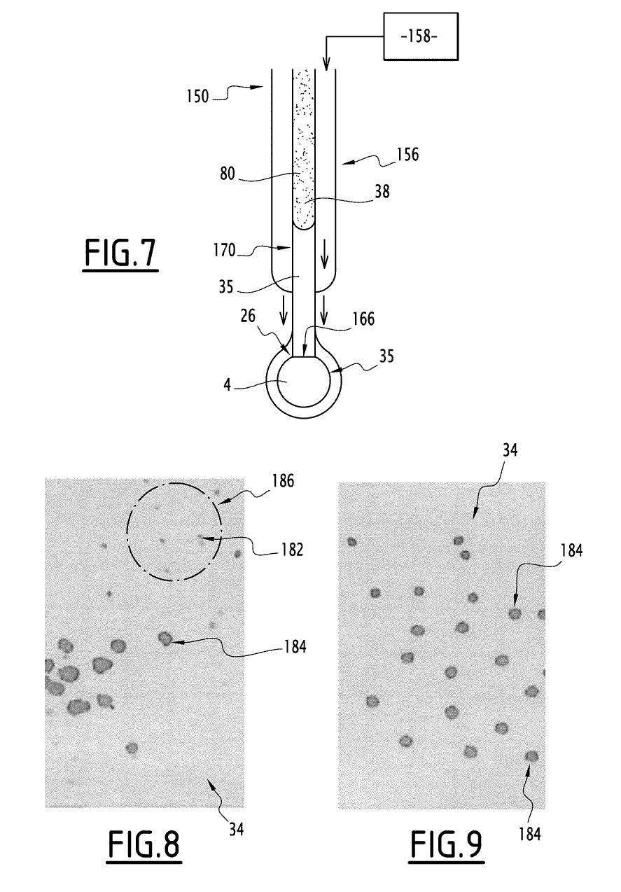

FIG. 7 shows a detailed representation of the pocket distribution device of FIG. 6, in a next step of a pocket distribution method;

FIG. 8 shows a pocket distribution result obtained after pocket distribution by the pocket distribution device of FIG. 6;

FIG. 9 shows another pocket distribution result obtained after pocket distribution by the pocket distribution device of FIG. 6.

In the following description, the terms “upstream” and “downstream” and the terms “inlet” and “outlet” are used in reference to the normal flow of fluids of the system.

The term “longitudinal” is defined with respect to the direction of the flow path in the chip. The planes that are perpendicular to the longitudinal direction are called “transverse planes”.

The term “diameter” of an element refers to the maximum extent of the element considered in a transverse plane.

The “droplet frequency” is the number of droplets per second passing in front of a fixed point of the circulation duct.

A first droplet recuperation system 1 is shown in FIG. 1.

The first droplet recuperation system 1 is provided for separately isolating and recuperating the droplets 4 of an emulsion 6.

An emulsion 6 of droplets 4 is shown in FIG. 2.

The emulsion 6 consists of a plurality of droplets 4 of an internal fluid 8 dispersed in an external fluid 10.

The emulsion 6 is substantially stable, this means that for a fixed volume of emulsion 6, the number and the volume of droplets 4 vary by less than 5% when the fixed volume of emulsion 6 is stored between −80° C. and 80° C. at 1 bar for 48 h.

The emulsion 6 is concentrated. This means that the volume fraction of droplets 4 in the emulsion 6 is between 30% and 40%. Each droplet 4 constitutes a closed compartment filled with internal fluid 8.

The droplets 4 of the emulsion 6 are preferably substantially monodisperse. The droplets 4 have, for example, a volume of between 2 μL and 2 μL.

At least some droplets 4 of the emulsion 6 are different from other droplets 4 of the emulsion 6.

Each droplet 4 comprises an internal fluid 8 potentially different from one droplet 4 to another.

Advantageously, the internal fluid 8 of all the droplets 4 comprises at least one common base 12. For example, the common base 12 is a buffer solution adapted to the survival of cells such as a phosphate-buffered saline solution or a culture medium.

The internal fluid 8 of each droplet 4 consists of elements 14 unique to the droplet 4 and the common base 12. The proportions of the unique elements 14 and the common base 12 and/or the nature of the unique elements 14 vary from one droplet 4 to another.

For example, the unique elements 14 of a droplet 4 are a cell and elements secreted by the cell, such as proteins.

Advantageously, more than 10% of the volume of the droplet 4 consists of the common base 12.

The internal fluid 8 of each droplet 4 is immiscible with the external fluid 10. Immiscible means that the partition coefficient between the two fluids is less than 10⁻³. The droplets 4 are well defined in the emulsion 6 and the exchanges between two adjacent droplets 4 in the emulsion 6 are limited to the soluble or slightly soluble compounds in the external fluid 10, i.e. with a partition coefficient greater than or equal to 10⁻³ and in cases where the compositions are different between neighboring droplets 4.

Advantageously, the common base 12 is immiscible with the external fluid 8.

In the example, the internal fluid 8 is an aqueous phase and the external fluid 10 is an organic phase including an oily phase.

The external fluid 10 comprises, for example, hydrofluoroethers such as FC-40 or HFE-7500, forming a fluorinated oil.

The external fluid 10 further comprises, advantageously, a surfactant. The surfactant is suitable for stabilizing the emulsion 6. The surfactant is, for example, a block copolymer of polyethylene glycol and perfluoropolyether (PEG-PFPE). For example, the concentration of surfactant in the external fluid 10 is between 2% and 5%.

The emulsion 6 is, for example, prepared by means of a preparation device and stored before being used in the first recuperation system 1.

The first recuperation system 1 is intended to separately recuperate the droplets 4 of the emulsion 6.

The first droplet recuperation system 1 shown in FIG. 1, comprises a separation chip 20, a control unit 21 and a device 22 for injecting the emulsion 6 into the chip 20. In addition, the first system recuperation device 1 comprises a device 24 for injecting carrier fluid 26 into the chip 20 to form a working fluid 28, a device 32 for injecting a separating fluid 33 into the chip 20 and a recuperation support 34.

As will be described later, the control unit 21 is able to control the injection into the chip 20 of the separating fluid 33 by the device 32 for injecting the separating fluid 33 in order to separate the working fluid 28 into a plurality of successive pockets 35 likely to contain a droplet 4, as shown in FIG. 1.

In addition, the first droplet recuperation system 1 comprises a sensor 36 capable of detecting the passage of successive droplets 4 of the emulsion 6 in the working fluid 28. The first droplet recuperation system 1 further comprises a discharge tube 38, an outlet detector 40 and a relative displacement device 42 of the support 34 with respect to the chip 20.

The chip 20 comprises a fluid flow duct 46 defining successively in the flow direction of the fluids, an inlet zone 48, a spacing zone 50 of the droplets advantageously having a measuring region 52, an injection zone 54 for the separating fluid 33 and a separating zone 56.

The circulation duct 46 extends along a longitudinal axis X.

The chip 20 is, in the example, a rectangular block extending along the longitudinal axis X and a transverse axis Y perpendicular to the longitudinal axis X. In addition, the chip has a thickness along an axis of elevation Z perpendicular to the longitudinal axis X and the transverse axis Y.

In the following, the terms “lower” and “higher” refer to the axis of elevation Z, perpendicular to the longitudinal axis X. The direction of the elevation axis Z is for example substantially vertical.

For example, the cross-section, i.e. along a plane comprising the transverse axis Y and the elevation axis Z, of the circulation duct 46 is rectangular. The circulation duct 46 is delimited by four side walls.

Alternatively, the cross-section may have other shapes.

The maximum area of the cross-section of the duct 46 is less than 1 mm².

The chip 20 is transparent at least in the measurement region 52. Advantageously, the chip 20 is made of transparent material, for example polydimethylsiloxane (PDMS).

The material of the chip 20 is impermeable to the carrier fluid 26. In a variant, the material of the chip 20 is, moreover, impermeable to the separating fluid 33, for example when the separating fluid 33 is a liquid.

The chip 20 has a first inlet 60 opening into the inlet zone 48 of the circulation duct 46, at least a second inlet 62 opening into the spacing zone 50 of the circulation duct 46, and at least a third inlet 64 opening into the injection zone 54 of the circulation duct 46. The chip 20 comprises an outlet 66 through which the flow duct 46 opens into the discharge tube 38.

The first inlet 60 is in fluidic communication upstream with the injection device 22 of the emulsion, as illustrated in FIG. 1.

The inlet zone 48 of the circulation duct 46 extends from the first inlet 60 to the spacing zone 50.

The shape of the circulation duct 46 in the inlet zone 48 is adapted to allow the injection of the emulsion 6 into the inlet zone 48 and the simultaneous passage of a droplet 4 towards the spacing zone 48.

In the example shown in FIG. 1, the circulation duct 46 in the inlet zone 48 has a first portion 68 and a second portion forming a convergent tip 70.

The first portion 68 has a constant diameter along the longitudinal axis X.

The second portion 70 opens into the spacing zone of the circulation duct. It allows the simultaneous passage of a droplet 4 to the spacing zone 48.

The second portion 70 has a convergent tip shape in the direction of flow of the fluids in a plane comprising the longitudinal axis X and the transverse axis Y.

The angle of the convergent tip 70 is adapted to prevent the droplets 4 coalescing. For example, the opposite side walls of the circulation duct 46 at the convergent tip 70 form an angle of between 45° and 70° between them.

The diameter of the first portion 68 is the maximum diameter of the convergent tip 70.

For example, the minimum diameter of the convergent tip 70 is substantially equal to the average diameter of the droplets 4.

The second inlet 62 is in fluid communication upstream with the injection device of the carrier fluid 26 as illustrated in FIG. 1.

The shape of the circulation duct 46 in the spacing zone 50 is adapted to allow the injection of the carrier fluid 26 between the droplets 4 of the emulsion 6.

Thus, the circulation duct 46 comprises in the spacing zone 50, a junction 72 with the second inlet 62.

Advantageously, the junction 72 comprises at least one secondary channel 74 with an angle of between 45° and 90° with respect to the longitudinal axis X and opening into the circulation duct 46.

In the example shown in FIG. 1, the junction 72 comprises two secondary channels 74 opening on either side of the circulation duct 46.

The circulation duct 46 has in the spacing zone 50 except for the junction 72, a cross-section of diameter smaller than that of the first portion of the vicinity of the inlet 60, for example, substantially equal to 400% of the diameter of the average of the droplets 4. Preferably, this diameter is equal to the minimum diameter of the convergent tip 70.

The spacing zone 50 extends from the inlet zone 48 to the injection zone 54.

Furthermore the spacing zone 50 has a measurement region 52 in which the droplets 4 are detected by the sensor 36, as will be described later. The dimension of this measurement region 52 is, for example, equal to the diameter of a droplet 4. Alternatively, the measurement region 52 may extend in a transverse plane on a surface equal to the section of the circulation duct 46.

The length of the spacing zone 50 is preferably greater than 3 times the diameter of the circulation duct 46.

The third inlet 64 is in fluidic communication upstream with the separator fluid injection device 32 as illustrated in FIG. 1.

The shape of the circulation duct 46 in the injection zone 54 is adapted to allow the injection of the separating fluid 33 between the droplets 4 of the working fluid 28.

Thus, the circulation duct 46 comprises, in the injection zone 54, a junction 76 with the third inlet 64.

The circulation duct 46 in the separation zone 56 has a flared shape so that the dimension of the circulation duct reaches the internal diameter of the discharge tube 38.

The diameter of the circulation duct 46 is greater at the outlet of the separation zone 56 than in the spacing zone 50.

The circulation duct 46 has a maximum diameter in the separation zone of between 10 μm and 2 mm, advantageously greater than the diameter of the droplet 4. The control unit 21 is able to control the flow rates of the different fluids 6, 26, 28, 33, to receive the signals from the sensor 36 and the outlet detector 40 and to record the characteristics of the droplets 4.

The control unit 21 is able to control the injection device 22 of an emulsion, the injection device 24 of the carrier fluid, and the injection device 32 of the separating fluid.

The injection device 22 of an emulsion is capable of injecting an emulsion 6 of droplets 4 of an internal fluid 8 dispersed in an external fluid 10 in the inlet zone 48 via the first inlet 60.

The control unit 21 is able to control the injection device 22 of the emulsion 6 so that it injects the emulsion 6 into the inlet zone 48 at a flow rate of between 1 μL/h and 500 μL/h and advantageously at a flow rate of 80 μL/h.

The injection device 22 of an emulsion comprises for example a container in which is placed a volume of the emulsion 6 between 1 nL and 2 mL. The injection device 22 of an emulsion further comprises a connection pipe for putting the container in fluidic communication with the first inlet 60 and a means for circulating the emulsion, as illustrated in FIG. 1.

For example, the injection device 22 of the emulsion comprises a syringe pump, a syringe filled with emulsion 6 and a connecting pipe.

The injection device 24 of the carrier fluid is suitable for injecting the carrier fluid 26 into the spacing zone 50 via the second inlet 62 in order to form a working fluid 28 in the circulation duct 46.

The control unit 21 is able to control the injection device 24 of the carrier fluid 26 so that it injects carrier fluid 26 into the spacing zone 50 through the second inlet 62 at a flow rate of between 5 μL/h. and 5 mL/h and advantageously at a flow rate of 1 mL/h.

The injection rate of the carrier fluid 26 is, for example, adjusted so that the frequency of the droplets 4 in the spacing zone 50 is, for example, between 0.5 droplets per second and 500 droplets per second and advantageously 30 droplets per second.

The injection device 24 of the carrier fluid 26 comprises for example a container in which is placed a volume of the carrier fluid 26 between 10 μl and 10 ml. The injection device 24 further comprises a connecting pipe for putting in fluidic communication the container and the second inlet 62 and a means for circulating the carrier fluid 26.

Similarly, the injection device 24 comprises for example a syringe pump, a syringe filled with the carrier fluid 26 and a connecting pipe.

The carrier fluid 26 is miscible with the external fluid 10.

For example, the carrier fluid 26 used is the same as the external fluid 10 i.e. the fluorinated HFE oil with the same surfactant with a concentration between 0% and 0.5%.

The working fluid 28 comprises the carrier fluid 26, the external fluid 10 and droplets 4 of emulsion 6 spaced apart from each other along the circulation duct 48.

The control unit 21 is able to circulate the working fluid 28 in the circulation duct 46 downstream of the spacing zone 50.

The control unit 21 imposes a fixed flow rate for the working fluid 28 by controlling the flow rates of the injection device 22 of the emulsion 6 and the injection device 24 of the carrier fluid 26. The control unit 21 controls in addition, the flow rate of the injection device 32 of the separating fluid 33. For example, the control unit 21 is able to vary the flow rate of the injection device 32 of the separating fluid 33 according to the presence or absence of a droplet 6 detected by the sensor 36 in the spacing zone.

The sensor 36 is able to detect the passage of successive droplets 4 of the emulsion 6 in the spacing zone 50. In addition, the sensor 36 is capable of making a measurement within the droplet 4. For example, the measurement is an optical measurement, such as a fluorescence measurement.

The control unit 21 is able to store the information measured by the droplet sensor 4 for each droplet 4.

The measurement depends on the internal fluid 8 present in the droplet 4. Advantageously, the measurement makes it possible to determine the nature or the concentration of the unique element 14 of each droplet 4.

The control unit 21 is able to trigger the injection of separating fluid as a function of the measurement of the sensor 36.

The injection device 32 of the separating fluid 33 is able to inject the immiscible separating fluid 33 with the carrier fluid 26 into the injection zone 54 in order to separate the working fluid 28 into a plurality of successive pockets 35 comprising the carrier fluid 26.

Each pocket 35 is isolated from the next pocket 35 by a separator 80 consisting of separating fluid 33.

The separating fluid 33 is immiscible with the carrier fluid 26.

The separating fluid 33 is preferably a gas.

In the example, the separating fluid 33 is air. The separator 80 is an air bubble.

The diameter of each pocket 35 is greater than or equal to that of the circulation duct 46.

The volume of each separator 80 is greater than twice the volume of a droplet 4. The diameter of each separator 80 is greater than or equal to that of the circulation duct 46. The diameter of each separator 80 is for example equal to the inside diameter of the discharge tube 38.

The control unit 21 is able to circulate the pockets 35 and the separators 80, in the separation zone, towards the outlet 66 of the chip 20.

The support 34 comprises at least one compartment 82 designed to receive a pocket 35. For example, the support 34 may be a petri dish.

Advantageously, the support 34 has several compartments 82 separated from each other.

For example, the support 34 is a 96-well plate, wherein each well is a separate compartment 82 for recuperation. Alternatively, the support 34 may be a 24-well or 384-well plate or the like.

The discharge tube 38 has an inlet 84 and an outlet 86 and an internal lumen 87 opening through the inlet 84 and the outlet 86. The internal lumen 87 extends in the extension of the circulation duct 46.

The inlet 84 of the discharge tube 38 is sealingly connected to the outlet 66 of the chip 20.

The outlet 86 of the discharge tube 38 is designed to be placed facing the compartment 82, for the recuperation of at least one pocket 35 comprising a droplet 4 in the compartment 82.

The discharge tube 38 is for example a Teflon capillary having an internal diameter advantageously greater than 0.1 mm.

The dimension of the discharge tube 38 is adapted to the desired pocket size.

The volume of the pockets 35 is greater than the volume of a droplet of diameter equal to the inside diameter of the discharge tube 38, in order to facilitate their display by the outlet detector 40 and their deposit in the support 34.

The outlet detector 40 is located downstream of the separation zone 56. Advantageously, the outlet detector 40 is able to successively detect each pocket 35 in the discharge tube 38.

Depending on the size of the droplets, the outlet detector 40 is also advantageously able to detect the droplets 4 in the discharge tube 38. The control unit 21 is able to control the displacement of the support 34.

In the example, the displacement device 42 is a robotic plate. The displacement device 42 is able to move the support 34 relative to the discharge tube 38 and to the chip 20. For example, the plate is able to move the support 34 horizontally at a speed of between 0.5 mm·s⁻¹ and 45 mm·s⁻¹.

Advantageously, the control unit 21 is able to control the displacement device 42 as a function of each droplet detection 4 by the sensor 36, so that a single pocket 35 comprising a droplet 4 detected at the detection step is recuperated in each compartment 82 of the support 34. Alternatively or additionally, the control unit 21 controls the displacement device 42 according to the signals detected by the outlet detector 40.

For example, the detection of the droplets 4 or pockets 35 by the outlet detector 40 makes it possible to trigger the movement of the displacement device 42 in order to put one droplet 4 per compartment 82. After each recuperation, the displacement device 42 is able to place the outlet 86 of the discharge tube 38 to face a different compartment 82 after each displacement of the support 34 relative to the chip 20.

A droplet recuperation method 4 according to the invention will now be described.

The first droplet recuperation system 1 is provided. The injection device 22 of the emulsion 6 is supplied with an emulsion 6 as previously described.

The emulsion 6 of droplets 4 is injected into the inlet zone 48 of the chip 20 by means of the injection device 22 of the emulsion 6. The emulsion 6 is circulated for example at a flow rate of 80 μL/h.

The droplets 4 of the emulsion 6 arrive one by one in the spacing zone 50 due to the convergent tip 70 of the inlet zone 48.

The carrier fluid 26 is injected into the spacing zone 50 by means of the injection device 24 of the carrier fluid 26 to form a working fluid in the circulation duct. The carrier fluid 26 is circulated for example at a flow rate of 1 mL/h.

Each droplet 4 is spaced apart from the other droplets 4 by carrier fluid 26.

The distance between each droplet 4 is, for example, greater than the inside diameter of the discharge tube 38. The distance between each droplet 4 in the spacing zone 50 is sufficient to be able to inject separating fluid 33 between the droplets 4 without disturbing the working fluid 28.

The working fluid 28 is conveyed in the circulation duct 46.

The droplets 6 in the working fluid 28 are spaced apart and ordered along the flow duct 46.

The droplets 6 of the working fluid 28 pass one by one in the measurement region 52.

A step of detecting the passage of successive droplets 6 in the measurement region 52 is implemented by the sensor 36.

The sensor 36 measures information relating to the droplet 6. For example, the measurement is a fluorescence measurement representative of the unique element 14 of the droplet 6. The collected information is for example an enzymatic activity, a number of cells, a biomass, or quantity of protein produced in the droplet.

The control unit 21 stores the number of the droplet 6 and the measured information in sequence.

The droplets 6 of the working fluid 28 pass one by one into the injection zone 54.

The control unit 21 triggers the injection of separating fluid 33 as a function of the measurement of the sensor 36, so that there is a separator 80 between each droplet 4. The separating fluid 33 is injected into the injection zone 54 by means of the injection device 32 of separating fluid. The separating fluid 33 separates the working fluid 28 into a plurality of successive pockets 35. The separating fluid 33 is injected between two successive droplets 4 of the working fluid 28. The injection of separating fluid 33 allows the formation of pockets 35 and separators 80.

Each separator 80 separates two successive pockets 35 of working fluid 28. It is immiscible with the pocket 35.

The pockets 35 are working fluid cavities 28 separated by the separator 80. The pockets 35 comprise mainly carrier fluid 26. At least one pocket 35, preferably more than 100% of the pockets 35, additionally contain one droplet 4 of the emulsion 6.

The volume of the pockets 35 is greater than the volume of a droplet of a diameter equal to the inside diameter of the discharge tube 38.

The injection flow rate of the separating fluid 33 by the separating fluid injection device 32 is adjusted by the control unit 21 so that each pocket 35 contains strictly less than two droplets 4. For example, the adjustment may be passive, wherein the injection rate of the separator fluid 33 is constant. Some pockets 35 are empty of droplets 4, while other pockets 35 only comprise one droplet 4.

Advantageously, the injection flow rate of the separating fluid 33 by the separating fluid injection device 32 is adjusted in real time by the control unit 21 so that each pocket 35 contains exactly one droplet 4 of the emulsion 6. For example, the detection of a droplet 4 by the sensor 36 triggers control by the control unit 21 of the injection of a determined volume of separating fluid 33 for the formation of a pocket 35. This active mechanism ensures that each pocket formed is not empty and contains only one droplet.

The frequency of formation of the pockets 35 depends on the size of the droplets 4. The greater the volume of the droplets 4, the slower is the frequency of formation of the pockets 35. The formation of the pockets 35 is, for example, carried out at a frequency of between 0.5 pockets per second and 500 pockets per second.

The pockets 35 are then conveyed into the discharge tube 38.

The pockets 35 and the separators 80 are conveyed in the separation zone 56 towards the outlet 66 of the chip by the control unit 21, wherein the circulation duct 46 has a larger and larger diameter. The flow rate of the fluids is preserved during this change of scale but the frequency of the droplets 4 is changed. Thus, the circulation frequency of the pockets 35 in the discharge tube 38 is less than the flow frequency of the droplets 4 at the outlet 66 of the spacing zone 50. This frequency decrease is proportional to the square of the ratio of the inside diameter of the discharge tube 38 on the diameter of the circulation duct 46.

The pockets 35 and the separators 80 enter successively into the discharge tube 38.

The change of scale makes it possible to modify the frequency of circulation of the droplets 4. For example, when there is a droplet 4 per pocket 35, the droplets 4 in the discharge tube 38 circulate at the circulation frequency of the pockets 35.

For example, the dimensions are adapted so that if the droplets 4 circulate at 100 droplets per second in front of a point of the measurement region 52, they flow at 6 droplets per second into the discharge tube 38.

Advantageously, the speed of circulation of the pockets 35 in the discharge tube 38 is less than the maximum speed of displacement of the displacement device 42.

Advantageously, each pocket 35 is detected by the outlet detector 40. In a variant, the droplets 4 in the pockets are detected by the outlet detector 40.

Then at least one pocket 35 comprising a droplet 4 is recuperated in a compartment 82 of the support 34. The pocket 35 is recuperated in the compartment 82 placed under the outlet 86 of the discharge tube 38.

The control unit 21 triggers the movement of the displacement device 42 as a function of the measurement of the outlet detector 40 so that each pocket 35 or droplet 4 is recuperated in a different compartment 82 of the support 34.

Each droplet 4 is monitored by the control unit 21. For example the droplets 4 are detected at the sensor 36 and are numbered. Each droplet 4 of the emulsion 6 is thus associated with both a measurement and the compartment 82 in which it has been recuperated.

In addition, the method comprises, after each recuperation step, a step of relative displacement of the support 34 relative to the chip 20, wherein the outlet 86 of the discharge tube 38 is placed opposite a different compartment 82 after each displacement of the support 34.

The displacement of the support 34 is controlled by the control unit 21 as a function of each detected droplet 4, so that a single pocket 35 comprising a droplet 4 detected at the detection step is recuperated in each compartment 82 of the support 34.

A second recuperation system 100 is presented with reference to FIG. 3. The second recuperation system differs from the first recuperation system 1 in that it comprises an injection device 102 of a complementary solution 104 in at least one pocket 35.

The complementary solution 104 is immiscible with the separating fluid 33. Moreover, the complementary solution 104 is advantageously miscible with the internal fluid 18 and immiscible with the carrier fluid 26.

For example, the added complementary solution 104 makes it possible to dilute the droplet 4 of the emulsion 6. As a variant, the added complementary solution 104 comprises a marker facilitating the detection of the droplet 4 within the pocket 35 by the outlet detector 40. Alternatively, the added complementary solution 104 is a cell lysis reagent or a reagent for facilitating the cryopreservation of the internal fluid droplet 4.

The control unit 21 is able to control the injection device 102 of the complementary solution 104.

The method for recuperating droplets with the second recuperation system 100 differs from the method previously described in that the method comprises a step of adding a complementary solution 104 in at least one pocket 35. For example, the same volume of complementary solution 104 is added in each pocket 35 by the injection device 102 of a complementary solution 104.

Advantageously, the pocket 35 in which the complementary solution is added comprises a droplet of emulsion 6 and the method additionally comprises a step of fusing the said droplet of emulsion 6 with the added complementary solution 104. The fusion is called passive. The low concentration of surfactant present in the carrier fluid 26 no longer makes it possible to stabilize the droplets 6 of the coalescence. As the droplet of emulsion and the droplet of complementary fluid are confined in the pocket 35 between two separators 80, there is a high probability of contact.

The invention which has just been described provides a method for recuperating droplets 4, which is more reliable and more accurate than the existing methods, allowing individual monitoring of each droplet 4. In fact, each droplet 4 is recuperated individually in a compartment 82 of the support 34.

Once the droplets 4 have been recuperated in the macroscopic support 34, it is possible to carry out analysis steps, chemical reactions or conventional biological reactions on the content of the droplets 4. For example, if the droplets 4 contain cells, the recuperation system 1, 100 makes it possible to recuperate the droplets 4 individually before culturing the cells separately.

The recuperation system 1, 100 makes it possible to recuperate individual droplets 4 from a small quantity of droplets 4 of an emulsion 6. For example, starting from 0.1 μL of emulsion 6 containing 10,000 droplets per μL, the recuperation system 1, 100 may individually recuperate 1000 droplets.

In addition, each droplet 4 is associated with a measurement signal. The recuperation system 1, 100 makes it possible to have a link between the individual information of the droplet 4 and the isolated droplet 4. Each droplet 4 analyzed is recuperable.

The measurement made in the measurement region 52 is accurate because the surface of the measurement region 52 is adapted to the volume of the droplet 4. The passage to a macroscopic scale makes it possible to recuperate the contents of the droplet 4 in a support 34 so that may be handled more easily. Finally the system 1, 100 is may be automated. In fact, the size of the pockets 35 facilitates the handling of the droplets 4 and allows the use of various instruments for the recuperation and after the recuperation.

The placement of a droplet 4 in each pocket 35 makes it possible in particular to handle a macroscopic object of significantly greater volume than that of an individual droplet 4, which facilitates handling and guarantees the integrity of the droplet 4.

In a variant, the outlet 66 of the chip opens directly opposite a compartment 82 of the support 34 and the displacement device 42 is able to place the outlet 66 of the chip 20 opposite a different compartment 82 after each displacement of the support 34 with respect to the chip 20.

In a variant, the droplet recuperation system comprises a device for preparing the emulsion 6 disposed upstream of the inlet zone 48 of the chip 20.

The flow rates are advantageously adjusted by the control unit 21 as a function of the maximum speed of displacement of the displacement device 42.

In one example, the recuperation system 1, 100 further comprises an incubation zone. The emulsion 6 comprises droplets 4 comprising one cell or no cells.

The method comprises culturing each recuperated cell. The analysis of the droplets 4 before the selection makes it possible, for example, to cultivate only the cells capable of generating an interesting clone. In addition, it is not necessary to carry out several subcultures of clones before obtaining a monoclonal culture since the cell is already isolated before culturing. This avoids having to perform multiple limit dilutions.

For example, in the case of the screening of bacteria synthesizing a compound of interest, the system makes it possible to associate the signal measured for each droplet 4 containing a bacterium or a colony derived from a single cell to the compartment 84 in which the droplet 4 has been recuperated. Thus, the bacterium is cultured in a culture medium adapted according to the measured information.

A third recuperation system 110 will be presented with reference to FIG. 4. The third recuperation system 110 differs from the recuperation systems 1, 100 previously described in that the injection of the emulsion 6 into the chip 20 is provided by a lower part of the chip 20.

As shown in FIG. 4, the chip 20 comprises an upper block 112 and a lower block 114 defining between them the flow duct 46. The chip 20 further comprises, in the inlet zone 48, an inlet connection block 116. In the inlet zone 48, the lower block 114 is sandwiched between the upper block 112 and the inlet connection block 116 in the elevation direction Z. For example, the upper block 112 and the connection block 116 is made of PDMS while the lower block 114 is made of glass.

The inlet connection block 116 defines an inlet duct 118 extending in the elevation direction Z.

In the inlet zone 48, the lower block 114 is pierced with an inlet orifice 120. The inlet orifice 120 traverses the entire thickness of the lower block 114 and opens through the upper face of the lower block 114 into the circulation duct 46 and the lower face of the lower block 114 in the inlet duct 118.

The inlet duct 118 is aligned with the inlet port 120. For example, the inlet duct 118 is centered with respect to the inlet port 120.

The diameter of the inlet port 120 is greater than the diameter of the inlet duct 118. For example, the diameter of the inlet duct 118 is 750 μm while the diameter of the inlet port 120 is 1.4 mm.

The inlet duct 118 opens downstream into the inlet port 120 and upstream through the first inlet 60 into an injection tube 122 connected to the injection device 22 of the emulsion.

The method of recuperating the droplets 4 with the third recuperation system 110 differs from the recuperation methods described above in that the injection of the emulsion 6 is facilitated.

In fact, the flow of droplets 4 passes directly from the injection tube 122 to the inlet duct 118, then through the inlet port 120 before arriving in the flow duct 46 without encountering obstacles. The apparent light is continuous and of increasing diameter in the direction of circulation of the emulsion 6, wherein the injection tube 122 to the inlet duct 118 and the inlet duct 118 to the inlet port 120, prevent blockages of droplets 4 in connection blind spots.

In this third recuperation system 110, during the transfer of the emulsion 6 into the chip 20, droplet losses 4 are limited.

The injection provided in the third recuperation system 110 is particularly advantageous for the emulsions 6 comprising an internal fluid 8 that is less dense than the external fluid 10. In fact, if the elevation direction Z is vertical, the buoyancy push favors the rising of the droplets 4 in the direction of the elevation Z in the inlet duct 118.

A fourth recuperation system 130 will be presented with reference to FIG. 5. The fourth recuperation system 130 differs from the recuperation systems 1, 100, 110 previously described in that the outlet of the pockets 35 and the separators 80 of the chip 20 is provided on an upper part of the chip 20.

As shown in FIG. 5, the chip 20 comprises an upper block 132 and a lower block 134 defining between them the circulation duct 46. The chip 20 further comprises, at the outlet 66 of the chip, a block of outlet connection 136. At the outlet 66, the upper block 132 is sandwiched between the lower block 134 and the inlet connection block 136 in the elevation direction Z.

The upper block 132 defines an outlet duct 138. The outlet duct 138 extends in the elevation direction Z, perpendicularly to the circulation duct 46. The outlet duct 138 opens out through the outlet 66 into the internal lumen 87 of the discharge tube 38. The diameter of the outlet duct 138 is smaller than the internal diameter of the discharge tube 38.

The connection block 136 defines an orifice 140 of greater diameter than the diameter of the outlet duct 138. The diameter of the port 140 is substantially equal to the external diameter of the discharge tube 38.

In one example, the discharge tube 38 has an inner diameter of 750 μm and an outer diameter of 1.6 mm, while the outlet duct 138 has a diameter of 500 μm and the port 140 has a diameter of 1.6 mm.

The discharge tube 38 is inserted into the port 140 of the connection block 136 so that the lumen of the outlet duct 138 and the internal lumen 87 of the discharge tube 38 are continuous. The upstream end 142 of the discharge tube 38 is in contact with the upper face of the upper block 132.

The method of recuperating the droplets 4 with the fourth recuperation system 130 differs from the methods previously described in that the transfer of the pockets and separators 80 from the chip 20 to the discharge tube 38 is facilitated.

In fact, the flow of pockets 35 and separators 80 passes directly from the flow duct 46 to the outlet duct 138, then into the lumen 87 of the discharge tube 38 without encountering any obstacle. The pockets 35 in circulation circulate in ducts 138, 87 whose diameter increases from the chip 20 to the discharge tube 38 in the direction of flow of the droplets 4 contained in the pockets 35 and the separators 80. In addition, because of the direction of the outlet duct 138, the droplets 4 are not blocked in a blind spot at the time of the change of scale. This makes it possible to prevent blockages of droplets or separator in blind connection angles.

The outlet of the chip 20 provided in this fourth recuperation system 130 is particularly advantageous when the carrier fluid 26 is less dense than the separator fluid 33. In fact, if the elevation direction Z is vertical, the buoyancy force promotes the droplets 4 to rise in the direction of elevation Z in the outlet duct 138 and in the inner lumen 87.

A fifth recuperation system 150 is presented with reference to FIGS. 6 to 9. The fifth recuperation system 150 differs from the recuperation systems 1, 100, 110, 130, previously described in that the system 150 comprises a device 152 for the distribution of pockets 35.

The pocket distribution device 152 comprises the discharge tube 38, a circulation device 154 of a plurality of successive pockets 35, wherein each pocket 35 is isolated from the next pocket 35 by a separator 80 consisting of separating fluid 33 in the internal lumen 87 of the discharge tube 38.

The device 152 for the distribution of pockets 35 further comprises a tip 156 adapted to receive the discharge tube 38 and a blowing unit 158.

The circulation device 154 is capable of controlling the flow rate of the pockets 35 in the internal lumen 87 of the discharge tube 38. For example, the circulation device 154 is controlled by the control unit 121. The circulation device 154 controls the injection device 22 of the emulsion 6, the device 24 for injecting the carrier fluid 26, and/or the device 32 for injecting the separating fluid 33 into the chip 20 so that the pockets 35 circulate in the internal lumen 87 at a flow rate of between 100 μL/h and 5 mL/h and advantageously at a flow rate of 2 mL/h.

The discharge tube 38 has a main portion 160 and an outlet portion 162 connected by a narrowing zone 164.

The internal lumen 87 of the discharge tube 38 opens onto an open mouth 166 in the outlet portion 162.

The main portion 160 extends from the upstream end 142 of the discharge tube 38, for example disposed at the outlet of the chip 66 to the narrowing zone 164. The outlet portion 162 extends from the narrowing zone 64 at the open mouth 166 located at the downstream end of the discharge tube 38.

The outer diameter of the outlet portion 162 of the discharge tube 38 is smaller than the outside diameter of the main portion 160 of the discharge tube 38. For example, the outer diameter of the outlet portion 162 is substantially equal to the inside diameter of the main portion 160.

For example, the main portion 160 has an outer diameter of 1.6 mm and an inner diameter of 0.75 mm, and the outlet portion 162 has an outer diameter of 0.75 mm and an internal diameter of 0.3 mm.

In addition, the recuperation device 152 advantageously comprises an injection device 168 of additional separating fluid 33. The additional separator fluid injection device 168 is able to add separating fluid 33 in at least one separator 80 flowing in the main portion 160 of the discharge tube 38. The additional separating fluid injection device 168 is suitable for adding more than 2 cm of separating fluid between the pockets 35.

The tip 156 is for example a glass tube. The tip 156 extends in the direction of elevation Z. The tip 156 has a through passage 170 in which the outlet portion 162 of the discharge tube 38 is disposed.

The tip 156 comprises a cylindrical upper portion 172 and a hollow lower portion 174 having a frustoconical or curved section. The through passage 170 extends in the direction of elevation Z and opens into the lower portion 174 through an orifice delimited by a collar 176.

The diameter of the orifice delimited by the collar 176 of the tip 156 is slightly greater than the external diameter of the outlet portion 162 of the tube 38. The internal diameter of the upper portion 172 is greater than the external diameter of the outlet portion 162 of the discharge tube 38.

The lower portion 174 of the tip 156 advantageously has a beveled shape of 45°.

The discharge tube 38 is placed in the through passage 170 of the tip 156 so that the discharge tube 38 protrudes out of the tip 156. The mouth 166 is outside the tip 156. For example, the mouth 166 of the discharge tube 38 is at a distance of between 1 mm and 10 mm from the neck 176 of the tip 156.

The outer wall 164 of the discharge tube 38 is supported on the neck 176 of the tip 156 at the outlet of the through passage 170.

The blowing unit 158 is able to inject a stream of air into the through passage 170 so that a portion of the air runs along the outer wall 164 of the discharge tube 38 to the mouth 166 of the discharge tube 38. For example, the blowing unit 158 comprises an injection tube 3 m long and 150 μm internal diameter, while the injection pressure at the inlet of the injection tube is between 500 mBar and 1600 mBar.

The pocket distribution device 152 comprises a control unit 180 able to control the blowing unit 158 so that it injects air into the through passage 170 at a flow rate of between 1 μL/h and 2 mL/h and advantageously at a flow rate of 500 μL/h.

In addition, the control unit 180 controls the pocket circulation device 154.

A pocket distribution method will now be described.

A distribution device 152 as previously described is provided. The pockets 35 and separators 80 are circulated in the internal lumen 87 by the circulation device 154.

In one example, additional separating fluid is injected into the separators 80 by the injection device 168.

Air is injected into the through passage 170 of the tip 156 by the blowing unit 158. The air flow rate and the flow rate of the pockets 35 are adjusted by the control unit 180 so that each pocket 35 detaches successively from the mouth 166 of the discharge tube 38.

This device improves the distribution of droplets.

FIG. 7 represents the ejection of a pocket 35. A part of the carrier fluid 26 of the pocket 26 adheres to the outer wall 164 of the discharge tube 138 by capillarity. The air flow along the outer wall 164 of the discharge tube 38 makes it possible to detach the pocket 35.

The injection of air by the blowing unit 158 through the tip 156 makes it possible to eject the pocket 35 from the discharge tube 38 before the arrival of the next pocket 35 while preventing the pocket 35 from becoming fixed to the mouth 166.

FIGS. 8 and 9 show the distribution results obtained for different experimental conditions. The recuperation support 34 is a sheet of paper.

These results were obtained with a flow of pockets in the discharge tube 38 maintained at three pockets per second by the control unit 180.

In the example of FIG. 8, the pockets 35 were recuperated on the support 34 under fragmentation conditions.

The pockets 35 are recuperated one by one on the support 34. Each pocket is ejected from the outlet before the arrival of the next pocket 35.

However, some pockets 35 become fragmented upon ejection. An airflow greater than 1.6 bar results in fragmentation of the individual pockets recuperated.

Each task 182 formed on the support 34 comes only from one pocket 35. The same pocket 35 which has fragmented during the ejection forms a group 186 of small visible spots on the support 34. Some pockets 35 do not fragment and form a wider spot 184.

In a second example of distribution shown in FIG. 9, the flow rates are adjusted so that the pockets 35 retain their integral volume during the ejection. The individual pockets are distributed without fragmentation. The spots 184 obtained on the support 34 have substantially the same diameter.

The adjustment of the parameters makes it easier to extract and locate the pockets 35 on the support 34.

1. Method for recuperating droplets, comprising:
provision of a chip having a fluid flow duct defining successively in a fluid flow direction, an inlet zone, a spacing zone, an injection zone and a separation zone,
injection of an emulsion of droplets of an internal fluid dispersed in an external fluid into the inlet zone,
injection of at least one carrier fluid miscible with the external fluid into the spacing zone to form a working fluid in the flow duct, comprising a carrier fluid and droplets of the emulsion spaced apart from each other along the duct,
conveyance of the working fluid in the circulation duct,
injection of a separating fluid immiscible with the carrier fluid into the injection zone to separate the working fluid into a plurality of successive pockets comprising the carrier fluid, wherein each pocket is isolated from the next pocket by a separator consisting of separating fluid,
conveyance of the pockets and separators in the separation zone to an outlet of the chip,
recuperation in a compartment of a recuperation support of at least one pocket comprising a droplet recuperated after conveyance.

2. Method according to claim 1, wherein the flow duct is wider in the separation zone than in the spacing zone.

3. Method according to any one of claim 1, wherein each pocket comprises the carrier fluid and strictly less than two droplets.

4. Method according to claim 1, wherein the outlet of the chip having an outlet.

5. Method according to claim 4, wherein the support comprises several compartments separated from each other, while the method comprises, after each recuperation, a relative displacement of the support with respect to the chip, wherein the outlet of the discharge tube is placed opposite a different compartment after each displacement of the support.

6. Method according to claim 1, comprising detecting the passage of successive droplets or detecting of the passage of successive pockets.

7. Method according to claim 6, wherein the support comprises several compartments separated from each other, while the method comprises, after each recuperation, a relative displacement of the support with respect to the chip, wherein the outlet of the discharge tube is placed opposite a different compartment after each displacement of the support and the displacement of the support is controlled according to each detection of droplets or each pocket detection, wherein a single pocket comprising a droplet detected at the detection is recuperated in each compartment of the support.

8. Method according to claim 6, wherein the detection of a droplet controls the injection of a volume of separating fluid and the formation of a pocket.

9. Method of claim 1, comprising a pocket detection step in a detection zone downstream of the separation zone.

10. Method according to claim 1, comprising adding a complementary solution in at least one pocket.

11. Method according to claim 10, wherein the pocket in which the complementary solution is added comprises a droplet of emulsion, while the method comprises fusing the said droplet of emulsion with the added complementary solution.

12. Droplet recuperation system, comprising:
a chip comprising a fluid circulation duct defining successively in the direction of circulation of the fluids, an inlet zone, a spacing zone, an injection zone and a separation zone,
an injection configured for injecting an emulsion of droplets of an internal fluid dispersed in an external fluid into the inlet zone,
an injector configured for injecting at least one carrier fluid that is miscible with the external fluid into the spacing zone, in order to form in the circulation duct a working fluid comprising the carrier fluid and droplets of the emulsion spaced from each other along the duct,
an injector configured for injecting a separating fluid immiscible with the carrier fluid into the injection zone to separate the working fluid into a plurality of successive pockets comprising carrier fluid, wherein each pocket is isolated from the next pocket by a separator consisting of separating fluid, and
a controller capable of circulating the working fluid in the circulation duct and conveying the pockets and the separators in the separation zone to an outlet of the chip,
a recuperation support, wherein the support comprises at least one compartment for the recuperation of at least one pocket comprising a droplet in the compartment.

13. Droplet recuperation system according to claim 12, wherein the outlet of the chip opens into a discharge tube having an outlet, wherein the support comprises a plurality of compartments separated from each other, while the system comprises a relative displacer of the support relative to the chip, after each recuperation, wherein the displacer is adapted to place the outlet of the discharge tube to face a different compartment after each displacement of the support with respect to the chip.

14. Droplet recuperation system according to claim 13, comprising a sensor capable of detecting the passage of successive droplets in the spacing zone wherein the displacer is controlled according to each detection of droplets, so that a single pocket comprising a droplet detected in the detection is recuperated in each compartment of the support.

15. Droplet recuperation system according to claim 12, wherein the outlet of the chip opens into a discharge tube, wherein the discharge tube defines an inner lumen opening on an open mouth, wherein the discharge tube comprises an outer wall and the system comprises a tip having a through passage, wherein the discharge tube is located in the through passage and the system comprises a blower configured for injecting a flow of air into the through-passage so that a portion of the air runs along the outer wall of the discharge tube to the mouth of the discharge tube.
